(19) United States
(12) Patent Application Publication
(10) Pub. No.: US 2024/0206673 A1
(43) Pub. Date: Jun. 27, 2024

(54) DEVICE FOR PREPARING A COFFEE BEVERAGE

(71) Applicant: Franke Kaffeemaschinen AG, Aarburg (CH)

(72) Inventor: Simon Müller, Muhen (CH)

(73) Assignee: Franke Kaffeemaschinen AG, Aarburg (CH)

(21) Appl. No.: 18/555,315

(22) PCT Filed: Apr. 5, 2022
(86) PCT No.: PCT/EP2022/058984

§ 371 Date: Oct. 13, 2023

(30) Foreign Application Priority Data
Apr. 13, 2021 (DE) 10 2021 109 252.3

(51) Int. Cl. A47J 31/52; A47J 31/46

(52) U.S. Cl. CPC A47J 31/52; A47J 31/461; A47J 31/468

(57) ABSTRACT

A return pump is provided in a coffee beverage preparing device having a brewing unit, to which hot water from a hot water heater can be supplied under pressure, and a beverage outlet which is connected to the brewing unit via an outlet line and via which a freshly brewed coffee beverage can be dispensed into a drinking vessel to be placed thereunder, the return pump being connected on the intake side in a fluid-conducting manner to the outlet line and opening on the delivery side into a drain or a collecting container in order to suction coffee beverage out of the coffee line before, during or after a brewing operation and to conduct the coffee beverage into the drain or collecting container. A controller activates the return pump and the return pump during pre-heating in which hot water is introduced into the brewing unit and/or the outlet line.

### CROSS-REFERENCE TO RELATED APPLICATIONS

This application is the U.S. National Phase of PCT Appln. No. PCT/EP2022/058984, filed Apr. 5, 2022, which claims priority from German Patent Application No. 10 2021 109 252.3, filed Apr. 13, 2021, the entire disclosures of which are incorporated by reference herein.

### TECHNICAL FIELD

The present invention relates to a device for preparing a coffee beverage having a brewing unit, to which hot water from a hot water heater can be supplied under pressure, and a beverage outlet which is connected to the brewing unit via an outlet line and via which a freshly brewed coffee beverage can be dispensed into a drinking vessel to be placed thereunder.

### BACKGROUND

Coffee machines on the market, such as for example fully automatic coffee machines or espresso machines, have a brewing chamber into which ground coffee is filled, the ground coffee optionally being compressed and hot water then being passed through under pressure. In some cases, such coffee machines have an integrated cleaning function, hot water or flushing liquid being conducted through the brewing chamber during this cleaning function. The flushing liquid can be dispensed into a vessel placed below the beverage outlet and tipped away manually by the user. However, it is also known to connect the outlet line leading to the beverage outlet directly to a drain or a collecting container via a corresponding switching valve, so that it is ensured that flushing liquid does not inadvertently pass into a drinking vessel. After the end of a brewing operation, the outlet line can also be connected to the drain or the collecting container via such a switching valve in order to prevent residual coffee from dripping out. A switching valve (3/2-way valve) arranged in the outlet line, however, has the drawback of a relatively high heat capacity and thus additionally cools the freshly brewed coffee on the path from the brewing unit to the beverage outlet.

### SUMMARY

The object of the present invention is to specify a device for preparing a coffee beverage which avoids the situation where the freshly brewed coffee is cooled on the path from the brewing unit to the beverage outlet.

The object is achieved by a device for preparing a coffee beverage having one or more of the features disclosed herein. Advantageous embodiments can be found below and in the claims.

In a device of the type mentioned in the introduction, a return pump is provided, the return pump being connected on the intake side in a fluid-conducting manner to the outlet line and opening on the delivery side into a drain or a collecting container in order to suction coffee beverage out of the coffee line before, during or after a brewing operation and to conduct the coffee beverage into the drain or collecting container. Instead of connecting the outlet line to a drainage line via a valve, in the context of the present invention liquid is thus suctioned out of the outlet line by negative pressure and conducted into the drainage line.

It is further provided that after a lengthy stoppage time and before the preparation of a coffee beverage with hot water, the device is pre-heated by using the return pump according to the invention. This can take place either by a hot water flow being conducted briefly through the brewing unit and the outlet line before the brewing unit is filled with ground coffee. Alternatively, the brewing unit can be provided with a separate heater and thus does not have to be pre-heated. In this case, it is possible for only the outlet line to be pre-heated by a hot water flow being conducted into the outlet line via an additional valve. In both cases, according to the invention the return pump is activated via the associated controller during such a pre-heating phase in order to suction away the hot water used for the pre-heating so that this hot water is not dispensed via the beverage outlet into a drinking vessel placed thereunder. In the same manner, the return pump can be used in the course of a cleaning operation in order to suction away cleaning liquid.

The supply of hot water from the hot water heater to the brewing unit via a hot water supply line is expediently carried out by means of a water pump which pumps water under pressure from a water connection or from a water tank in the direction of the brewing unit. The water pump can be provided in the hot water supply line leading from the hot water heater to the brewing unit. Expediently, however, the hot water pump is located on the feed side of the hot water heater in the cold water supply line thereof and thus pumps cold water to the hot water heater which in turn conducts hot water under the pressure of the pump to the brewing unit. The hot water heater can be designed in a manner known per se as a hot water boiler or as a flow heater.

In a preferred embodiment, the device has a programmable controller for activating the return pump. A plurality of functions can be implemented by such a controller. It can preferably be provided here that the return pump is activated by the controller such that residues of the coffee beverage remaining in the outlet line are suctioned away following a brewing operation. As a result, coffee is prevented from dripping out of the beverage outlet. Moreover, it is thus ensured that with the next preparation of a product no coffee beverage which has cooled down in the meantime is present in the coffee line, so that only a freshly brewed coffee beverage is dispensed to the beverage outlet.

The liquid residues can be suctioned away from the outlet line after every single preparation process. Alternatively, it is also possible to empty the outlet line by carrying out suctioning only after a certain stoppage time. Thus, a plurality of coffee beverages can be dispensed directly one after the other without suctioning being carried out. Only if no further beverages are prepared over a long period of time is the outlet line emptied by suctioning. It is also possible to activate the return pump briefly before starting to prepare a coffee and thus to ensure that no liquid residues are present in the outlet line.

In addition, however, a specific change to the taste of a prepared coffee beverage can also be achieved by means of the return pump. To this end, the controller is designed to activate the return pump such that, during the brewing operation of a coffee beverage, parts of the freshly brewed coffee beverage are suctioned away (“drained away”) in a time-controlled and targeted manner and thus are not dispensed via the beverage outlet into the drinking vessel of the user. This is based on the recognition that different aroma carriers are released from the ground coffee over the extraction time. Thus, the first part (for example 0 to 10 seconds) of a coffee tastes rather acidic, while the last part tastes rather bitter. During a preparation process, drainage can be carried out by the return pump for undesired extraction time periods. For example, drainage can be carried out during the starting phase in order to obtain less acid in the end product.

A particularly advantageous development results when the controller is designed such that by activating the return pump the pumping speed thereof is varied during operation in order to vary the quantity of the coffee beverage dispensed per time unit via the outlet during the brewing operation. Thus, it is possible during specific extraction time periods not to drain away the beverage components fully but only partially, by reducing the pumping speed of the suction pump. Thus, for example, 40% of the coffee beverage can be drained away during the time period 2 to 5 seconds by the pump being activated in this time interval at a reduced pumping speed. Different taste profiles of the finished coffee beverage can be produced by predetermining the activation times and the delivery rate.

In a development of the invention, a brewing valve can be provided upstream of the brewing unit in a hot water supply line, the brewing valve being opened for starting the brewing operation and being closed after the brewing operation has been terminated. The controller can be designed to activate the return pump before, together with or after the closure of the brewing valve. Accordingly, the outlet line is emptied by suctioning shortly before a brewing operation has been terminated, together with the termination thereof or only after the brewing operation has been terminated and the brewing valve has been closed.

In a preferred development, a back-pressure valve is arranged between the brewing unit and the beverage outlet in the outlet line. The pressure in the brewing unit or a flow rate through the brewing unit can be controlled in a targeted manner by this back-pressure valve. Preferably, it is provided here that the return pump branches off from the outlet line downstream of the back-pressure valve. On the one hand, therefore, the brewing pressure of the brewing unit is not applied to the return pump during a brewing operation. On the other hand, the return suction line can be emptied by suctioning as far as the beverage outlet without the resistance of the back-pressure valve.

In an alternative embodiment, instead of being connected directly to the outlet line, the return pump can also be connected upstream of the brewing unit to the hot water supply line or an outflow of the brewing valve which can be connected to the hot water supply line. In this case, the coffee beverage can be suctioned back through the brewing unit during the operation of the return pump. Thus the return pump is connected to the outlet line in a fluid-conducting manner via the brewing unit.

In a preferred embodiment, the return pump is designed as a peristaltic pump. Such a pump has proved to be particularly robust relative to hot and potentially corrosive liquids (acidic coffee) and relative to deposits which can be formed over time.

### BRIEF DESCRIPTION OF THE DRAWINGS

Further advantages and embodiments of the present invention are found in the following description of exemplary embodiments with reference to the figures, in which:

FIG. 1 shows a flow diagram of a coffee preparation device with a return pump connected to the outlet line in a first exemplary embodiment,

FIG. 2 shows a second exemplary embodiment with an additional back-pressure valve arranged in the outlet line,

FIG. 3 shows an alternative exemplary embodiment with the back-pressure valve arranged in the suction line,

FIG. 4 shows an exemplary embodiment of a coffee preparation device with a return pump connected via a brewing valve upstream of the brewing unit,

FIG. 5 shows an alternative exemplary embodiment with a return pump connected between the brewing assembly and the brewing valve,

FIG. 6 shows a further alternative exemplary embodiment with a return pump connected upstream of the brewing valve, and

FIG. 7 shows an exemplary embodiment with a heater in the brewing unit and a valve for pre-heating the outlet line.

### DETAILED DESCRITION

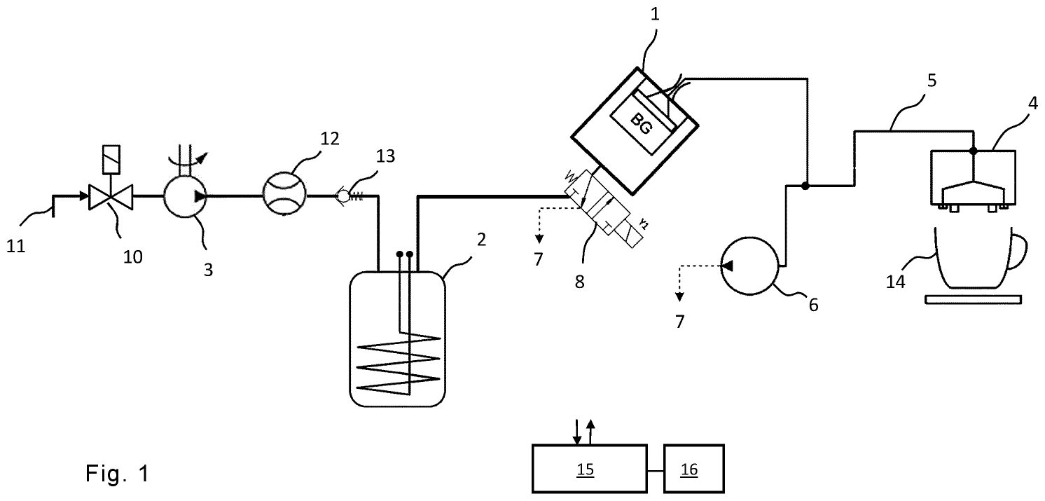

The construction of a device for preparing coffee beverages which can be used, for example, in a fully automatic coffee machine or an espresso machine is shown in FIG. 1 in a so-called water flow diagram. The preparation device comprises a brewing unit 1, a hot water boiler 2, a water pump 3 on the feed side, and a beverage outlet 4 for dispensing freshly brewed coffee beverages and which is connected via an outlet line 5 to the brewing unit 1. A return pump 6 is also connected to the outlet line 5, the return pump opening on the delivery side into a drain 7 or a collecting container. A brewing valve 8 which is designed as a 3/2-way valve is located in a hot water feed line between the hot water boiler 2 and the brewing unit 1. This brewing valve selectively connects the hot water line, which comes from the hot water boiler 2, to the brewing unit 1 or the brewing unit 1 to the drain 7 or a corresponding collecting container.

A main water valve 10 is located in the direction of flow upstream of the water pump 3, the preparation device being connected by the main water valve to a drinking water supply line 11. On the delivery side the pump 3 is connected to the feed of the hot water boiler 2 via a flow sensor 12, frequently also denoted as a flow meter, and a non-return valve 13. Hot water is supplied from the hot water boiler 2 to the brewing unit 1 by the water pump 3 applying pressure to the hot water boiler 2. A controller 15 with a user interface 16 controls the function of the preparation device and the components thereof. The controller can be implemented by a correspondingly programmed microprocessor, further control and regulating processes being able to be implemented thereby in a fully automatic coffee machine.

The brewing unit 1 comprises in a manner known per se a brewing chamber into which portioned, freshly ground coffee is filled, and preferably a heater (see FIG. 7, 20) by which the brewing unit can be pre-heated and kept warm. A brewing unit which can be used in the context of the present invention is described, for example, in EP 2561778 A1 to which full reference is made in order to avoid unnecessary repetition.

The brewing unit is designed such that it can be opened in order to fill a portioned quantity of ground coffee which has previously been freshly ground into portions in a grinder of the fully automatic coffee machine. Moreover, after the brewing operation the remaining coffee grounds can be discarded into a coffee grounds container when the brewing unit is open. The brewing unit also has a movable piston (not shown) which compresses the filled-in ground coffee against a brewing filter located in the brewing chamber. After the piston has moved back, the pressurized brewing water can flow through the compressed ground coffee.

The freshly brewed coffee beverage flows out of the brewing unit 1 via the outlet line 5 to the beverage outlet 4 and therefrom into a drinking vessel 14 placed thereunder. After the brewing operation has been terminated the return pump 6 can be activated via the controller 15, the return pump suctioning away coffee beverage remaining in the outlet line 5 and introducing the coffee beverage into the drain 7 or a collecting container optionally connected to the pump. Thus, coffee is prevented from dripping out of the beverage outlet 4. The residual quantity of coffee beverage still present in the outlet line can thus be completely and reliably emptied. This has the following advantages: the start behavior (outflow behavior) of the next product is implemented without dripping or splashing, since the gas/coffee mixture can be completely drawn off. Moreover, the residual quantity of coffee does not additionally cool the next product. Moreover, the taste of the next product is not impaired by the residual quantity of coffee beverage.

Moreover, via the return pump 6 it is possible to achieve in a targeted manner changes to the taste of the dispensed beverage, by drainage being carried out during certain extraction time periods, i.e. carrying out suctioning into the drain 7. For example, drainage can be carried out during the starting phase in order to obtain fewer acids. Moreover, it is possible for the pump to regulate the quantity of coffee which is dispensed into the drinking vessel during specific extraction times. Thus, for example, 40% of the coffee can be drained away during the time period of 2 to 5 seconds, by the pumping speed of the return pump 6 being correspondingly adapted.

The function of the coffee preparation device is determined by the controller unit 15. This controller unit reads the different sensors, such as for example the flow meter 12, and activates the valves 8 and 10 and the pumps 3 and 6 and the brewing unit 1. Naturally, it is possible to provide further sensors for pressure, temperature, flow etc., not shown here for the sake of clarity, the measurement values thereof being read by the controller unit 15.

The controller unit 15 also controls an automatic cleaning operation in which flushing liquid is pumped through the brewing unit 1 and the outlet line 5 and activates, in particular, the return pump 6 which suctions flushing liquid from the outlet line 5 and conducts it into the drain 7. The controller unit 15 also controls a heating operation in which hot water is pumped through the brewing unit 1 and the outlet line 5, in order to pre-heat these components. In this case the return pump 6 is also activated in order to suction the flushing water out of the outlet line into the drain 7.

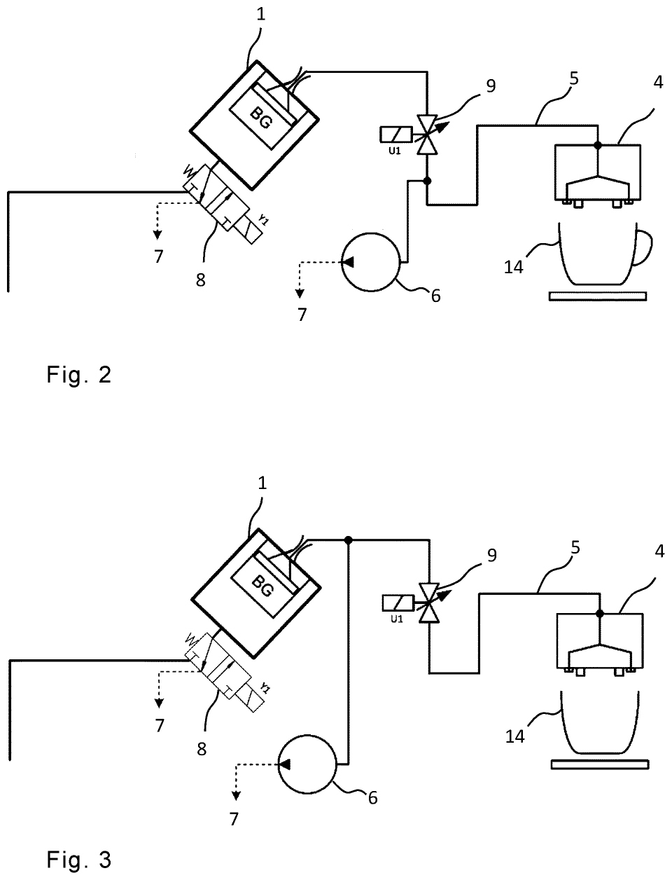

Variants and modifications of the coffee preparation device shown in FIG. 1 are explained in the following exemplary embodiments. In each case, only the fluid path from the hot water boiler 2 is shown here. In the exemplary embodiment shown in FIG. 2, additionally a controllable back-pressure valve 9 is located in the outlet line 5. This back-pressure valve is preferably implemented as a needle valve which is activated by a motor and which brings about a flow resistance in the outlet line so that the water pressure prevailing at the brewing unit 1 does not exclusively drop via the coffee cake received in the brewing chamber, but drops at the back-pressure valve 9 as a function of the opening state of the back-pressure valve 9. The back-pressure valve 9 can be regulated by means of the controller 15 such that a specific flow rate or a specific total flow time of a predetermined quantity of brewing water or a specific pressure in the brewing unit 1 is achieved. The return pump 6 is expediently connected downstream of the back-pressure valve 9 to the outlet line 5, so that it can suction away freshly brewed coffee beverage from the outlet line 5 irrespective of the opening state of the back-pressure valve 9 after a brewing operation has been terminated or even during a brewing operation.

In an alternative embodiment shown in FIG. 3, the return pump 6 is connected upstream of the back-pressure valve 9 to the return suction line 5, so that freshly brewed coffee beverage can be suctioned away directly downstream of the brewing unit 1. For emptying the outlet line 5, expediently the back-pressure valve 9 can be fully opened after the brewing operation has been terminated, so that the coffee beverage can be suctioned away by the return pump 6 without additional resistance and thus in a reliable and rapid manner.

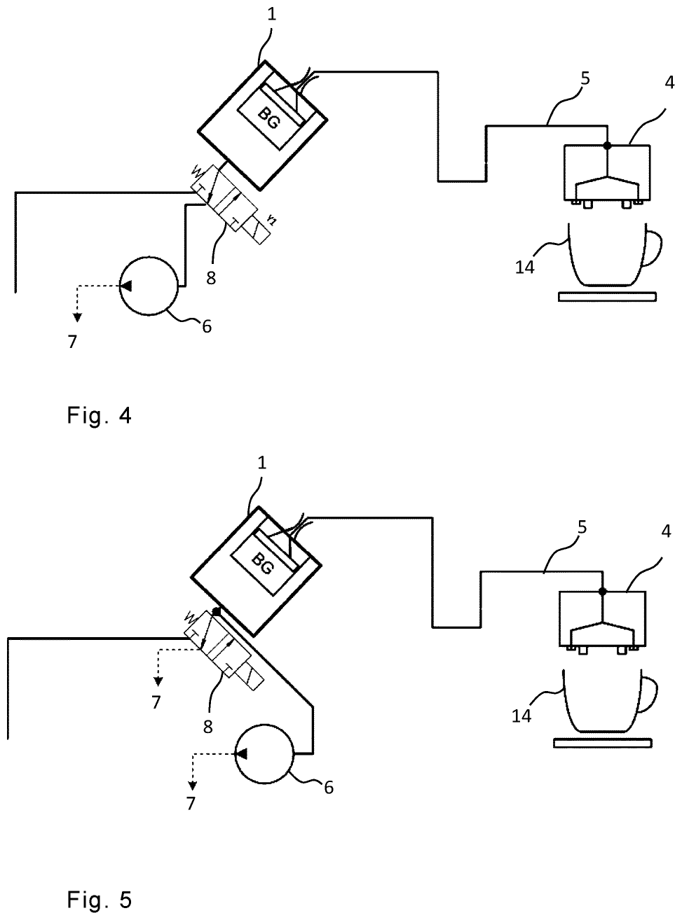

In the embodiment shown in FIG. 4, the return pump 6 is connected to the third connection of the brewing valve 8 (3/2-way valve), such that when the brewing valve is closed, the brewing unit 1 can be emptied in the direction of the drain 7 via the return pump 6. The outlet line 5 can be emptied by being suctioned through the brewing unit 1. To this end, the brewing piston of the brewing unit 1 is expediently moved back and the ground coffee which is received in the brewing chamber is discarded into a coffee grounds container (not shown).

Alternatively, as shown in FIG. 5, the return pump 6 can also be connected in the connecting line between the brewing valve 8 and the brewing unit 1. In this case when the brewing valve is closed, the fluid remaining in the brewing unit 1 can also be suctioned away via the return pump 6 and conducted into the drain 7.

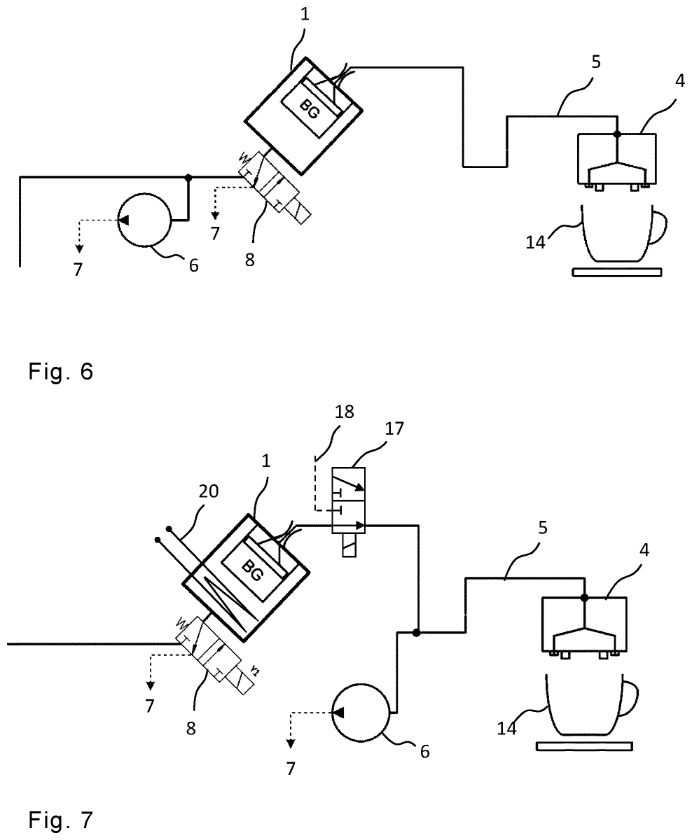

Finally in FIG. 6 an embodiment is shown in which the return pump 6 is connected upstream of the brewing valve 8. In this case, after a brewing operation has been terminated, the brewing valve is initially closed and fluid contained in the supply line can be drained off into the drain via the brewing valve 8. Subsequently, the brewing valve can be opened again so that coffee beverage remaining in the brewing unit 1 and the outlet line 5 can be suctioned back and discharged into the drain 7 by means of the return pump 6.

As already explained, the return pump 6 is preferably designed as a peristaltic pump so that the movable parts of the pump do not come into contact with the hot and potentially corrosive coffee beverage. Alternatively, however, other correspondingly robust pump types can also be used.

In FIG. 7 an exemplary embodiment is shown which corresponds substantially to that shown in FIG. 1. Additionally, an electric heater 20 of the brewing unit 1 is shown, the brewing unit being able to be pre-heated thereby. A switching valve 17 is also located in the outlet line downstream of the brewing unit 1. In normal operation this switching valve connects the outlet of the brewing unit 1 to the outlet line 5. For pre-heating the outlet line after a lengthy stoppage time, the valve 17 can be switched by the controller 15 in order to conduct a hot water flow through the outlet line 5. The inlet 18 of the switching valve 17 is to this end connected to a hot water heater, namely the hot water boiler 2 of FIG. 1. During this heating operation, the return pump 6 is activated via the controller 15 in order to suction away the hot water used for the pre-heating, so that this hot water is not dispensed via the beverage outlet 4 into a drinking vessel 14 placed thereunder. By pre-heating the outlet line 5 and the brewing unit 1, the situation is avoided that a freshly brewed coffee beverage cools down in the coffee machine before it reaches the drinking vessel 14. By the operation of the return pump 6 during the pre-heating, the situation is avoided that at the start of a coffee extraction process the outlet line 5 is filled with water which then would be dispensed into the drinking vessel during a coffee extraction process and would water down the coffee beverage.

1. A device for preparing a coffee beverage, the device comprising:
a brewing unit (1), to which hot water from a hot water heater (2) is suppliable under pressure;
a beverage outlet (4) connected to the brewing unit (1) via an outlet line (5) and via which a freshly brewed coffee beverage is dispensable into a drinking vessel (14) to be placed thereunder;
a return pump (6) connected on an intake side in a fluid-conducting manner to the outlet line (5) and which opens on a delivery side into a drain (7) or a collecting container in order to suction coffee beverage out of the outlet line (5) before, during or after a brewing operation and to conduct the coffee beverage into the drain (7) or collecting container; and
a controller (15) for activating the return pump (6), the controller (15) is configured to allow hot water to be introduced into the outlet line (5) or into the brewing unit (1) and outlet line (5) during a pre-heating operation and to activate the return pump (6) during the pre-heating operation.

2. The device as claimed in claim 2, wherein the controller (15) is further configured to activate the return pump (6) such that residues of the coffee beverage remaining in the outlet line (5) are suctioned away following a brewing operation.

3. The device as claimed in claim 2, wherein the controller (15) is further configured to activate the return pump (6) such that, during the brewing operation of a coffee beverage, parts of the freshly brewed coffee beverage are drained away in a time-controlled and targeted manner.

4. The device as claimed in claim 4, wherein the controller (15) is further configured, by activating the return pump (6), to vary a pumping speed thereof during operation in order to vary a quantity of the coffee beverage dispensed per time unit via the outlet (4) during the brewing operation.

5. The device as claimed in claim 2, further comprising a brewing valve (8) which is arranged upstream of the brewing unit (1) in a hot water supply line and which is opened for starting the brewing operation and which is closed after the brewing operation has been terminated, and the controller (15) is further configured to activate the return pump (6) before, together with or after the closure of the brewing valve (8).

6. The device as claimed in claim 1, further comprising a back-pressure valve (9) arranged between the brewing unit (1) and the beverage outlet (4) in the outlet line (5), and the suction line of the return pump (6) branches off from the outlet line (5) downstream of the back-pressure valve (9).

7. The device as claimed in claim 1, wherein a suction line of the return pump (6) is connected upstream of the brewing unit (1) to the hot water supply line or an outlet of the brewing valve (8) which is connectable to the hot water supply line such that coffee beverage is suctioned back through the brewing unit (1) during the operation of the return pump (6).

8. The device as claimed in claim 1, wherein the return pump (6) comprises a peristaltic pump.

9. The device as claimed in claim 1, wherein for carrying out the pre-heating operation the controller (15) is further configured to activate briefly a hot water flow through the brewing unit (1) and the outlet line (5) before the brewing unit (1) is filled with ground coffee.

10. The device as claimed in claim 1, wherein the brewing unit (1) is provided with a heater (20) and the controller (15) is further configured to activate a hot water flow through the outlet line (5) via a valve (17) for carrying out the pre-heating operation.
